(19) United States
(12) Patent Application Publication
(10) Pub. No.: US 2013/0163814 A1
(43) Pub. Date: Jun. 27, 2013

(54) IMAGE SENSING APPARATUS, INFORMATION PROCESSING APPARATUS, CONTROL METHOD, AND STORAGE MEDIUM

(71) Applicant: CANON KABUSHIKI KAISHA, Tokyo (JP)

(72) Inventor: Hideo Takiguchi, Kawasaki-shi (JP)

(73) Assignee: CANON KABUSHIKI KAISHA, Tokyo (JP)

(21) Appl. No.: 13/690,154

(22) Filed: Nov. 30, 2012

(30) Foreign Application Priority Data
Dec. 21, 2011 (JP) 2011-280245

(51) Int. Cl. G06K 9/00

(52) U.S. Cl. CPC G06K 9/00288
USPC 382/103

(57) ABSTRACT

Face recognition data to be used in recognizing a person corresponding to a face image is managed upon associating the feature amount of the face image, a first person's name, and a second person's name different from the first person's name with each other for each registered person. A person corresponding to a face image included in a captured image is identified using the feature amount managed in the face recognition data, and the second person's name for the identified person is stored in a storage in association with the captured image. When the image stored in the storage is read out and displayed on a display device, the first person's name which corresponds to the second person's name associated with the readout image is displayed on the display device together with the readout image.

### BACKGROUND OF THE INVENTION

1. Field of the Invention

The present invention relates to an image sensing apparatus, an information processing apparatus, a control method, a storage medium and, particularly, to a face recognition technique of identifying a person corresponding to a face image included in an image.

2. Description of the Related Art

Applications which allow the users to browse image files accumulated in a storage, such as image browsing software, are available. Such an image browsing application is used upon being installed on an information processing apparatus such as a PC. In recent years, there are image browsing applications that are able to implement a face recognition algorithm by which images of face regions each including the face of a person registered in advance are picked up. In face recognition processing, a database (also called face recognition data or a face dictionary), in which the feature amount of a face region obtained by analyzing a face image in advance is registered for each person, is looked up so that a matching search of the feature amount is performed for a face detected from the image, thereby identifying a person corresponding to the detected face.

Also, a certain type of image sensing apparatus such as a digital camera generates a face dictionary upon input of a person's name in capturing a face image, and performs face recognition processing using the generated face dictionary. When the image sensing apparatus performs face recognition processing, a face dictionary is held in a finite storage area of the image sensing apparatus. In general, the face of a person changes due to time factors such as age, and this change may degrade the accuracy of face recognition processing. That is, when a face dictionary is held in a finite storage area, the accuracy of face recognition processing improves by frequently updating the face dictionary. Japanese Patent Laid-Open No. 2007-241782 discloses a technique of adding and updating a feature amount (template) used in face detection processing, although it does not specifically relate to face recognition processing.

By holding a face dictionary by the image sensing apparatus in this way, face recognition results, that is, person's names can be displayed by superposition on an image of a person on a viewfinder in, for example, image sensing. This also makes it possible to store a captured image in association with a person's name included in this image.

As a display device serving as a viewfinder of an image sensing apparatus, a display device with a small display size is commonly used. That is, when face recognition results, that is, person's names are displayed by superposition on the viewfinder in the above-mentioned way, problems may be posed as, for example, a plurality of person's names overlap each other, or the visibility of the viewfinder degrades upon being shielded by the person's names.

To combat these problems, it is possible to represent a person's name, to be registered in the face dictionary, using a simple character string including a minimum number of characters, such as a nickname. Unfortunately, when a captured image associated with a person's name such as a nickname is searched for by the image browsing application of the information processing apparatus, the search accuracy may degrade as, for example, images associated with identical nicknames or partially overlapping images are extracted.

Also, it is often the case that the person's name registered in the face dictionary is looked up only in face dictionary registration. That is, when the user uses the image browsing application to search for a specific person, using his or her ordinarily acknowledged full name instead of his or her nickname, a desired search result may not be obtained. Especially when the type of character encoding scheme which uses characters capable of being input to or displayed on the image sensing apparatus is limited, a person's name corresponding to this character encoding scheme is registered in the face dictionary, but may not always correspond to a character encoding scheme which uses a character string used in a search by the user.

### SUMMARY OF THE INVENTION

The present invention has been made in consideration of the above-mentioned problems of the related art technique. The present invention provides an image sensing apparatus, an information processing apparatus, a control method, and a storage which achieve at least one of the display of a face recognition result while ensuring a given user visibility, and the storage of an image compatible with a flexible person's name search.

The present invention in its first aspect provides an image sensing apparatus comprising: a management unit configured to manage face recognition data, which is to be used in recognizing a person corresponding to a face image, and in which a feature amount of the face image, a first person's name, and a second person's name different from the first person's name are managed in association with each other for each registered person; a face recognition unit configured to identify a person, corresponding to a face image included in a captured image, using the feature amount managed in the face recognition data; a storage unit configured to store the second person's name for the person, identified by the face recognition unit, in a storage in association with the captured image; and a display control unit configured to read out the image stored in the storage, and display the readout image on a display unit together with the first person's name managed in the face recognition data in association with the second person's name associated with the readout image.

Further features of the present invention will become apparent from the following description of exemplary embodiments with reference to the attached drawings.

### BRIEF DESCRIPTION OF THE DRAWINGS

FIG. 1 is a block diagram showing the functional configuration of a digital camera 100 according to an embodiment of the present invention;

FIG. 2 is a block diagram showing the functional configuration of a PC 200 according to the embodiment of the present invention;

FIG. 3 is a flowchart illustrating camera face dictionary editing processing according to the embodiment of the present invention;

FIG. 4 is a view showing the data structure of a face dictionary according to the embodiment of the present invention;

FIG. 5 is a flowchart illustrating PC face dictionary editing processing according to the embodiment of the present invention;

FIG. 6 is a flowchart illustrating image capture processing according to the embodiment of the present invention;

FIG. 7 is a flowchart illustrating face recognition processing according to the embodiment of the present invention;

FIG. 8 is a flowchart illustrating person's image search processing according to the embodiment of the present invention;

FIG. 9 is a flowchart illustrating connection time processing according to the embodiment of the present invention;

FIG. 10 is a flowchart illustrating identical face dictionary determination processing according to the embodiment of the present invention;

FIG. 11 is a flowchart illustrating identical face dictionary determination processing according to the first modification of the present invention; and

FIG. 12 is a flowchart illustrating person's name merge processing according to the second modification of the present invention.

### DESCRIPTION OF THE EMBODIMENTS

### Embodiment

An exemplary embodiment of the present invention will be described in detail below with reference to the accompanying drawings. Note that an example in which the present invention is applied to a digital camera and PC which provide practical examples of an image sensing apparatus and an information processing apparatus, respectively, and are capable of face recognition processing using face recognition data will be given in one embodiment to be described hereinafter. However, the present invention is applicable to an arbitrary apparatus capable of face recognition processing using face recognition data.

In this specification, a “face image” exemplifies an image of the face region of a person, which is picked up from an image including the person. Also, a “face dictionary” exemplifies face recognition data which includes at least one face image of each person, and data of the feature amount of a face region included in each face image, and is used in matching processing of face recognition processing. Note that the number of face images to be included in the face dictionary is determined in advance.

<Configuration of Digital Camera 100>

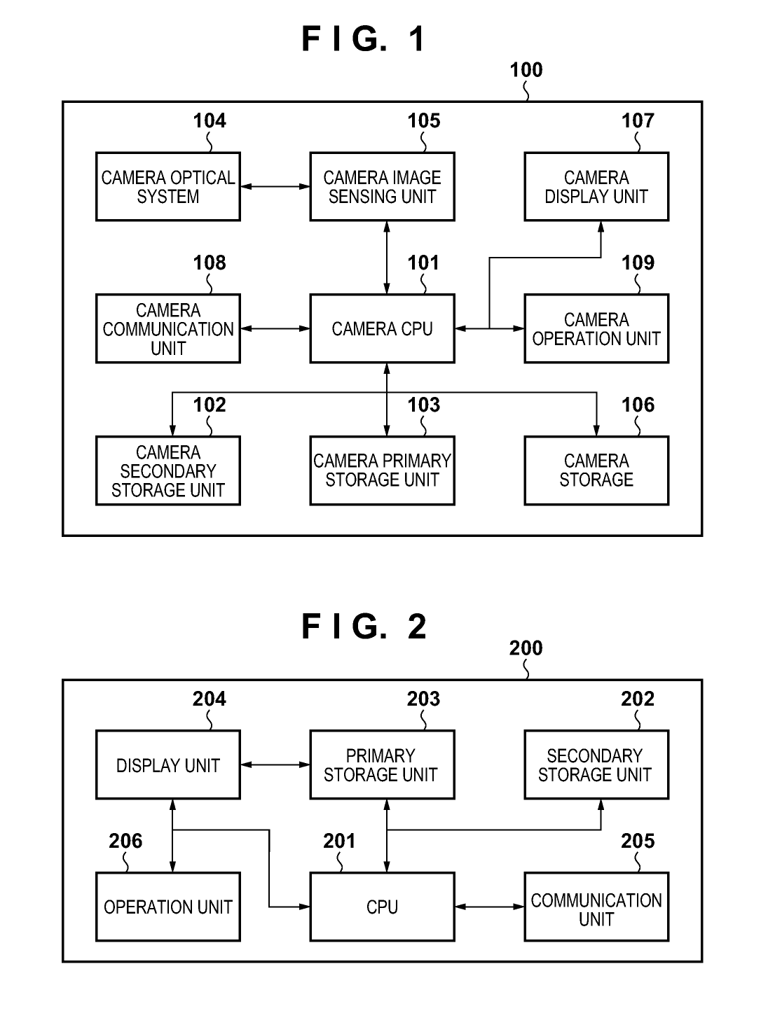

FIG. 1 is a block diagram showing the functional configuration of a digital camera 100 according to the embodiment of the present invention.

A camera CPU 101 controls the operation of each block of the digital camera 100. More specifically, the camera CPU 101 reads out the operating programs of image capture processing and other types of processing stored in a camera secondary storage unit 102, expands them into a camera primary storage unit 103, and executes them, thereby controlling the operation of each block.

The camera secondary storage unit 102 serves as, for example, a rewritable nonvolatile memory, and stores, for example, parameters necessary for the operation of each block of the digital camera 100, in addition to the operating programs of image capture processing and other types of processing.

The camera primary storage unit 103 serves as a volatile memory, and is used not only as an expansion area for the operating programs of image capture processing and other types of processing, but also as a storage area which stores, for example, intermediate data output upon the operation of each block of the digital camera 100.

A camera image sensing unit 105 includes, for example, an image sensor such as a CCD or CMOS sensor, and an A/D conversion unit. The camera image sensing unit 105 photo-electrically converts an optical image formed on the image sensor by a camera optical system 104, applies various types of image processing including A/D conversion processing to the converted image, and outputs the processed image as a sensed image.

A camera storage 106 serves as a storage device detachably connected to the digital camera 100, such as an internal memory, memory card, or HDD of the digital camera 100. In this embodiment, the camera storage 106 stores an image captured by image capture processing, and a face dictionary to be looked up in face recognition processing by the digital camera 100. The face dictionary stored in the camera storage 106 is not limited to a face dictionary generated by an image browsing application executed by a PC 200, and may be generated by registering a face image captured by the digital camera 100. Although the face dictionary is assumed to be stored in the camera storage 106 in this embodiment, the practice of the present invention is not limited to this. Any face dictionary may be used as long as it is stored in an area that can be accessed by the browsing application of the PC 200, or an area in which data can be written in response to a file write request, such as the camera secondary storage unit 102. Alternatively, the face dictionary may be stored in a predetermined storage area by the camera CPU 101 upon being transmitted from the PC 200.

A camera display unit 107 serves as a display device of the digital camera 100, such as a compact LCD. The camera display unit 107 displays, for example, a sensed image output from the camera image sensing unit 105, or an image stored in the camera storage 106.

A camera communication unit 108 serves as a communication interface which is provided in the digital camera 100, and exchanges data with an external apparatus. The digital camera 100 and the PC 200 as an external apparatus are connected to each other via the camera communication unit 108, regardless of whether the connection method is wired connection which uses, for example, a USB (Universal Serial Bus) cable, or wireless connection which uses a wireless LAN. The PTP (Picture Transfer Protocol) or the MTP (Media Transfer Protocol), for example, can be used as a protocol for data communication between the digital camera 100 and the PC 200. Note that in this embodiment, the communication interface of the camera communication unit 108 allows data communication with a communication unit 205 (to be described later) of the PC 200 using the same protocol.

A camera operation unit 109 serves as a user interface which is provided in the digital camera 100 and includes an operation member such as a power supply button or a shutter button. When the camera operation unit 109 detects the operation of the operation member by the user, it generates a control signal corresponding to the operation details, and transmits it to the camera CPU 101.

<Configuration of PC 200>

The functional configuration of the PC 200 according to the embodiment of the present invention will be described below with reference to FIG. 2.

A CPU 201 controls the operation of each block of the PC 200. More specifically, the CPU 201 reads out, for example, the operating program of an image browsing application stored in a secondary storage unit 202, expands it into a primary storage unit 203, and executes it, thereby controlling the operation of each block.

The secondary storage unit 202 serves as a storage device detachably connected to the PC 200, such as an internal memory, HDD, or SSD. In this embodiment, the secondary storage unit 202 stores a face dictionary for each person generated in the digital camera 100 or PC 200, and an image which includes this person and is used to generate the face dictionary, in addition to the operating program of the image browsing application.

The primary storage unit 203 serves as a volatile memory, which is used not only as an expansion area for the operating program of the image browsing application and other operating programs, but also as a storage area which stores intermediate data output upon the operation of each block of the PC 200.

A display unit 204 serves as a display device connected to the PC 200, such as an LCD. Although the display unit 204 is implemented as an internal display device of the PC 200 in this embodiment, it will readily be understood that the display unit 204 may serve as an external display device connected to the PC 200. In this embodiment, the display unit 204 displays a display screen generated using GUI data associated with the image browsing application.

A communication unit 205 serves as a communication interface which is provided in the PC 200, and exchanges data with an external apparatus. Note that in this embodiment, the communication interface of the communication unit 205 allows data communication with the camera communication unit 108 of the digital camera 100 using the same protocol.

An operation unit 206 serves as a user interface which is provided in the PC 200 and includes an input device such as a mouse, a keyboard, or a touch panel. When the operation unit 206 detects the operation of the input device by the user, it generates a control signal corresponding to the operation details, and transmits it to the CPU 201.

<Camera Face Dictionary Editing Processing>

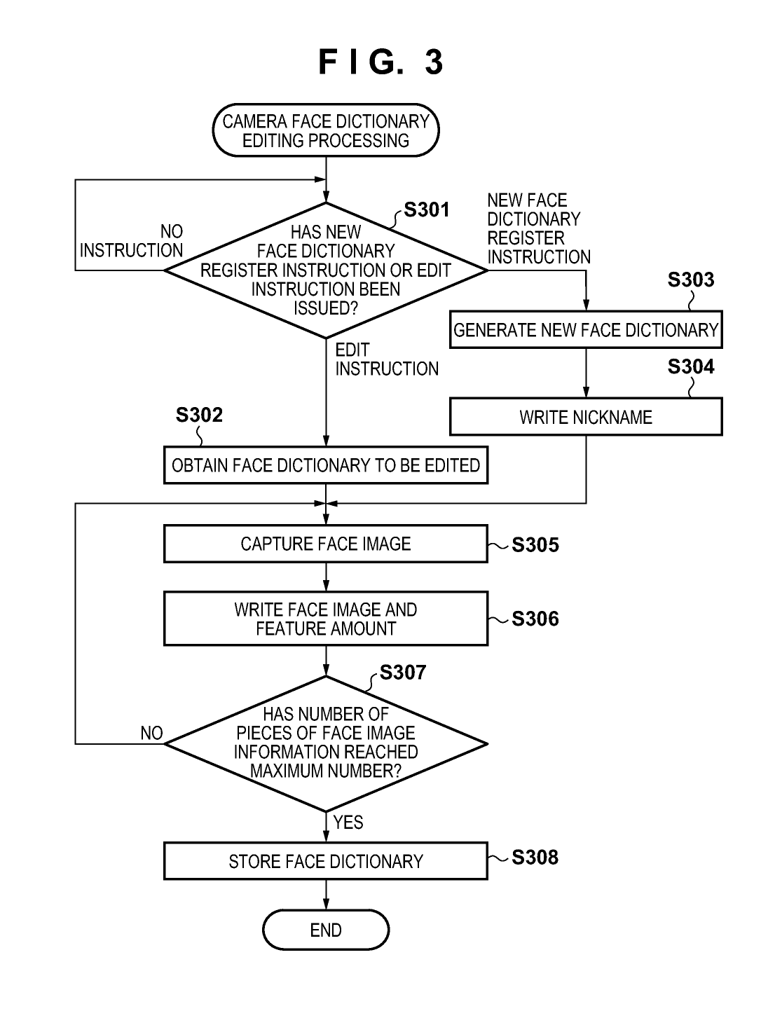

Camera face dictionary editing processing of generating or editing a face dictionary for one target person by the digital camera 100 having the above-mentioned configuration according to this embodiment will be described in detail with reference to a flowchart shown in FIG. 3. The processing corresponding to this flowchart can be implemented by, for example, making the camera CPU 101 read out a corresponding processing program stored in the camera secondary storage unit 102, expand it into the camera primary storage unit 103, and execute it. Note that the camera face dictionary editing processing starts as the camera CPU 101 receives, from the camera operation unit 109, a control signal indicating that, for example, the user has set the mode of the digital camera 100 to a face dictionary registration mode.

(Data Structure of Face Dictionary)

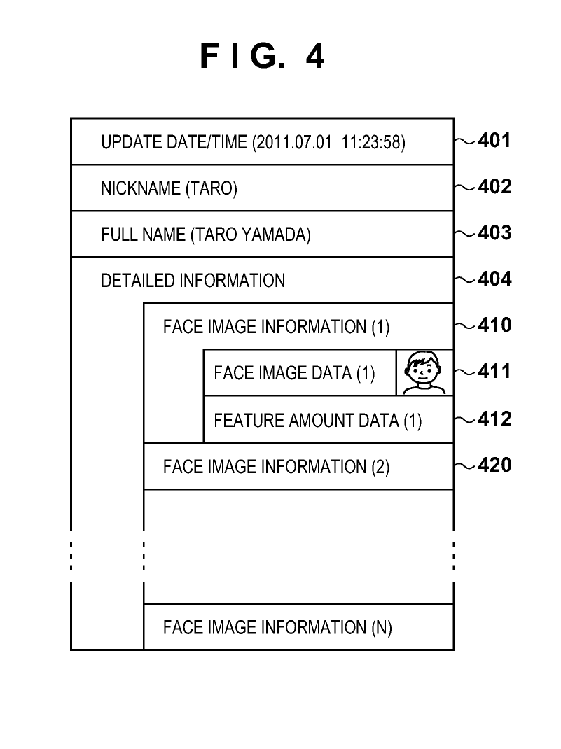

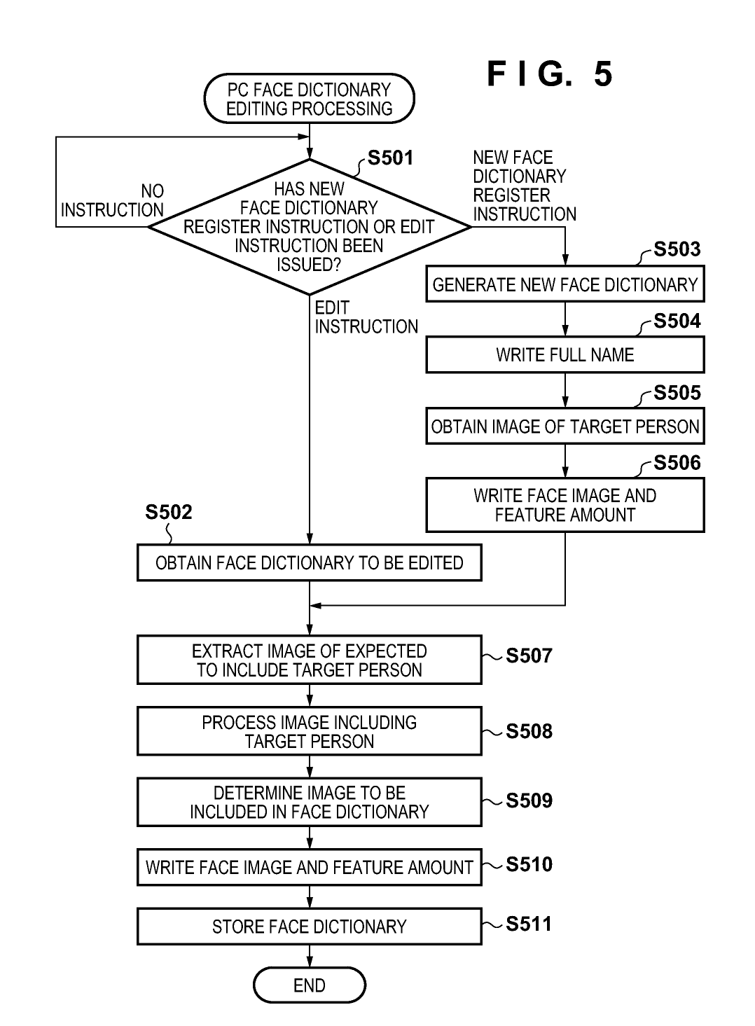

The data structure of a face dictionary according to this embodiment will be described first with reference to FIG. 4. Note that in this embodiment, one face dictionary is generated for each person. However, the practice of the present invention is not limited to this, and one dictionary may include face recognition data for a plurality of persons as long as a feature amount can be managed for each person inside the digital camera 100.

As shown in FIG. 4, a face dictionary for one target person includes an update date/time 401 as the date/time when the face dictionary is edited, a nickname 402 (first person's name) as a simple person's name for the target person, a full name 403 (second person's name) of the target person, and at least one piece of detailed information 404 of a face image (face image information (1) 410, face image information (2) 420, . . . , face image information (N)).

Also, taking the face image information (1) 410 as an example, each piece of face image information included in the detailed information includes:

1. face image data (1) 411 obtained by extracting the face region of a target person from an arbitrary image, and resizing it to an image with a predetermined number of pixels,

2. feature amount data (1) 412 indicating the feature amount of the face region of the face image data (1) 411.

Although the full name of a target person is included in a face dictionary as a second person's name in this embodiment, the information of a person's name included in the field of a second person's name is not limited to the full name of a target person. In this embodiment, the face dictionary includes a plurality of person's names, that is, a first person's name and second person's name in order to achieve a flexible search for person's images corresponding to various person's names in the image browsing application of the PC 200. That is, an image including a person identified by face recognition processing is associated with a plurality of person's names as metadata, thereby searching for images including the target person using a larger number of keywords.

Also, general digital cameras and digital video cameras are often incompatible with the input of characters in various character categories by the user, as described above. The digital camera 100 in this embodiment is assumed to be incompatible with the input and display of characters in various character categories, and compatible with the input and display of only characters represented by, for example, the ASCII code. The digital camera 100 in this embodiment displays, on the camera display unit 107, a face recognition result, that is, a person's name, obtained by face recognition processing using a face dictionary, together with a sensed image by, for example, superposition on the sensed image. At this time, a face recognition result, that is, a person's name to be displayed on the camera display unit 107 is obtained from a face dictionary, and needs to be represented by a character code capable of being displayed in the digital camera 100, that is, the ASCII code. Also, when a person's name is displayed by superposition on a sensed image as a face recognition result, a simple person's name can be used in order to ensure a given visibility of the sensed image, as described above. Hence, in this embodiment, the nickname 402 to which a simple person's name is input corresponds to the ASCII code (first character code) capable of being displayed on the camera display unit 107 of the digital camera 100. Also, in this embodiment, to ensure a given visibility, the maximum data length of the nickname 402 is limited to a predetermined value or less so as to be shorter than that of the full name 403.

Also, because the frequencies of character input and arbitrary character display in the digital camera 100 are low, the character code capable of being input and displayed in the digital camera 100 can have a small number of patterns of byte representation, and a small total amount of character image data for display, in terms of suppressing rise in cost of a storage area. This means that the nickname 402 can correspond to a one-byte character encoding scheme that uses, for example, the ASCII code, uses a small number of patterns of byte representation, as in this embodiment. However, in zones where two-byte characters are commonly used in input of characters described in official languages, especially in, for example, the Asian zone, when a captured image is searched for using a person's name, two-byte characters are expected to be used instead of one-byte characters. In this embodiment, the full name 403 corresponds to two-byte characters represented by, for example, the Shift-JIS code or the Unicode widely used in the PC 200, so as to be compatible with a search for an image associated with a face recognition result using two-byte characters in the image browsing application of the PC 200. Although the first person's name corresponds to a one-byte character encoding scheme, and the second person's name corresponds to a two-byte character encoding scheme in this embodiment, the practice of the present invention is not limited to this. That is, the first and second person's names need only correspond to different character encoding schemes in order to achieve a flexible search for person's images corresponding to person's names represented by various character encoding schemes as images associated with the person's names as face recognition results.

Note that in this embodiment, the first person's name corresponds to a character code capable of being input and displayed in the digital camera 100, while the second person's name corresponds to a character code incapable of being input or displayed in the digital camera 100. Hence, in this embodiment, a second person's name to be registered in a face dictionary generated in the digital camera 100 is input on the PC 200 when the digital camera 100 is connected to the PC 200.

Also, although a face image and the feature amount of the face region of the face image are included in a face dictionary as detailed information used for face recognition of a target person in this embodiment, the information included in the face dictionary is not limited to this. Since face recognition processing can be executed as long as either a face image or a feature amount is available, at least one of a face image and the feature amount of the face image need only be included in a face dictionary.

Upon execution of camera face dictionary editing processing, the camera CPU 101 determines in step S301 whether the user has issued a new face dictionary register instruction or existing face dictionary edit instruction. More specifically, the camera CPU 101 determines whether it has received, from the camera operation unit 109, a control signal corresponding to a new face dictionary register instruction or existing face dictionary edit instruction. If the camera CPU 101 determines that the user has issued a new face dictionary register instruction, it advances the process to step S303. If the camera CPU 101 determines that the user has issued an existing face dictionary edit instruction, it advances the process to step S302. If the camera CPU 101 determines that the user has issued neither a new face dictionary register instruction nor an existing face dictionary edit instruction, it repeats the process in step S301.

In step S302, the camera CPU 101 accepts an instruction to select a face dictionary to be edited among existing face dictionaries stored in the camera storage 106. More specifically, the camera CPU 101 displays, on the camera display unit 107, a list of face dictionaries currently stored in the camera storage 106, and stands by to receive, from the camera operation unit 109, a control signal indicating that the user has selected a face dictionary to be edited. The list of face dictionaries displayed on the camera display unit 107 may take a form which displays, for example, the character string of the nickname 402, or one representative image among face images included in each face dictionary. When the camera CPU 101 receives a control signal corresponding to the selection operation of a face dictionary from the camera operation unit 109, it stores information indicating the selected face dictionary in the camera primary storage unit 103, and advances the process to step S305.

On the other hand, if the camera CPU 101 determines in step S301 that the user has issued a new face dictionary register instruction, it generates a face dictionary (new face dictionary data) that is null data (initial data) in all its fields in the camera primary storage unit 103 in step S303.

In step S304, the camera CPU 101 accepts input of a nickname to be displayed as a face recognition result for the new face dictionary data generated in the camera primary storage unit 103 in step S303. More specifically, the camera CPU 101 displays, on the camera display unit 107, a screen generated using GUI data for accepting input of a nickname. The camera CPU 101 then stands by to receive, from the camera operation unit 109, a control signal indicating completion of input of a nickname by the user. When the camera CPU 101 receives, from the camera operation unit 109, a control signal indicating completion of input of a nickname, it obtains the input nickname and writes it in the field of the nickname 402 of the new face dictionary data in the camera primary storage unit 103. Note that when the digital camera 100 in this embodiment generates a face dictionary, the user must input the nickname 402 to be used to display a face recognition result.

In step S305, the camera CPU 101 obtains a face image of a target person to be included in the face dictionary. More specifically, the camera CPU 101 displays, on the camera display unit 107, a message for prompting the user to capture an image of the face of a target person. The camera CPU 101 then stands by to receive, from the camera operation unit 109, a control signal indicating that the user has issued an image capture instruction. When the camera CPU 101 receives the control signal corresponding to the image capture instruction, it controls the camera optical system 104 and camera image sensing unit 105 to execute image capture processing to obtain a sensed image.

In step S306, the camera CPU 101 performs face detection processing for the sensed image obtained in step S305 to extract an image (face image) of a face region. The camera CPU 101 further obtains the feature amount of the face region of the extracted face image. The camera CPU 101 writes face image data and feature amount data of each face image in the face image information of the face dictionary data selected in step S302, or the new face dictionary data generated in step S303.

In step S307, the camera CPU 101 determines whether the number of pieces of face image information included in the face dictionary data of the target object has reached a maximum number. If the camera CPU 101 determines that the number of pieces of face image information included in the face dictionary data of the target object has reached the maximum number, it advances the process to step S308; otherwise, it returns the process to step S305.

In this embodiment, the maximum number of pieces of face image information, that is, face images to be included in one face dictionary is set to five. In the camera face dictionary editing processing, a face dictionary which registers a maximum number of face images is output in response to a new face dictionary generate instruction or existing face dictionary edit instruction. Note that when an existing face dictionary edit instruction is issued, if the face dictionary to be edited is generated from, for example, less than a maximum number of face images by PC face dictionary editing processing (to be described later), the camera CPU 101 need only simply add face image information. However, if the face dictionary to be edited has a maximum number of pieces of face image information, the camera CPU 101 need only, for example, accept selection of a face image to be deleted after a face dictionary to be edited is selected in step S302, and add pieces of face image information in a number corresponding to the number of deleted face images in the processes of steps S305 to S307.

In step S308, the camera CPU 101 stores the face dictionary data of the target person in the camera storage 106 as a face dictionary file. At this time, the camera CPU 101 obtains the current date/time, and writes and stores it in the update date/time 401 of the face dictionary data of the target person.

<PC Face Dictionary Editing Processing>

PC face dictionary editing processing of generating or editing a face dictionary for one target person by the PC 200 according to this embodiment will be described in detail with reference to a flowchart shown in FIG. 5. The processing corresponding to the flowchart shown in FIG. 5 can be implemented by, for example, making the CPU 201 read out a corresponding processing program stored in the secondary storage unit 202, expand it into the primary storage unit 203, and execute it. Note that the PC face dictionary editing processing starts as the user issues a new face dictionary generate instruction or existing face dictionary edit instruction on the image browsing application running on the PC 200.

In step S501, the CPU 201 determines whether the user has issued a new face dictionary register instruction or existing face dictionary edit instruction. More specifically, the CPU 201 determines whether it has received, from the operation unit 206, a control signal corresponding to a new face dictionary register instruction or existing face dictionary edit instruction. If the CPU 201 determines that the user has issued a new face dictionary register instruction, it advances the process to step S503. If the CPU 201 determines that the user has issued an existing face dictionary edit instruction, it advances the process to step S502. If the CPU 201 determines that the user has issued neither a new face dictionary register instruction nor an existing face dictionary edit instruction, it repeats the process in step S501.

In step S502, the CPU 201 accepts an instruction to select a face dictionary to be edited among existing face dictionaries stored in the secondary storage unit 202. More specifically, the CPU 201 displays, on the display unit 204, a list of face dictionaries currently stored in the secondary storage unit 202, and stands by to receive, from the operation unit 206, a control signal indicating that the user has selected a face dictionary to be edited. The list of face dictionaries displayed on the display unit 204 may take a form which displays, for example, the character string of the full name 403, or one representative image among face images included in each face dictionary. When the CPU 201 receives a control signal corresponding to the selection operation of a face dictionary from the operation unit 206, it stores information indicating the selected face dictionary in the primary storage unit 203, and advances the process to step S507.

On the other hand, if the CPU 201 determines in step S501 that the user has issued a new face dictionary register instruction, it generates new face dictionary data that is null in all its fields in the primary storage unit 203 in step S503.

In step S504, the CPU 201 accepts input of a full name expected to be mainly used in a person's name search of the image browsing application running on the PC 200 for the new face dictionary data generated in the primary storage unit 203 in step S503. More specifically, the CPU 201 displays, on the display unit 204, a screen generated using GUI data for accepting input of a full name. The CPU 201 then stands by to receive, from the operation unit 206, a control signal indicating completion of input of a full name by the user. When the CPU 201 receives, from the operation unit 206, a control signal indicating completion of input of a full name, it obtains the input full name and writes it in the field of the full name 403 of the new face dictionary data in the primary storage unit 203. Note that in the PC face dictionary editing processing, the user must input a full name corresponding to a character code different from a character code capable of being input and displayed in the digital camera 100. However, the CPU 201 may accept input of a nickname.

Also, a UI for accepting input of a nickname may be displayed to allow both acceptance and omission of input of a nickname in steps subsequent to step S504. Moreover, when input of a nickname by the user is omitted, a given number may be set as a default.

Upon this operation, when this face dictionary is used in the camera, it is possible to reduce the frequency of problems that no nickname is displayed, or no name is displayed in image capture despite the presence of a face dictionary.

In step S505, the CPU 201 obtains an image including a target person to be registered in the face dictionary among images stored in the secondary storage unit 202. More specifically, the CPU 201 displays, on the display unit 204, a list of images stored in the secondary storage unit 202, and stands by to receive, from the operation unit 206, a control signal indicating that the user has selected an image including the target person. When the CPU 201 receives a control signal corresponding to the selection operation of an image including the target person from the operation unit 206, it stores the selected image in the primary storage unit 203, and advances the process to step S506. Note that in this embodiment, the user is instructed to select an image including only the target person in the above-mentioned selection operation. Also, at least one image including the target person need only be selected by the user.

In step S506, the CPU 201 performs face detection processing for the image including the target person, which is selected in step S505, to extract a face image. The CPU 201 obtains the feature amounts of the face regions of all extracted face images, and stores all of the obtained feature amount data in the primary storage unit 203.

In step S507, the CPU 201 extracts an image expected to include the target person among the images stored in the secondary storage unit 202 using, as templates, all feature amount data included in the face dictionary selected in step S502 or all feature amount data obtained in step S506. More specifically, first, the CPU 201 selects one of the images stored in the secondary storage unit 202, and identifies a face region by face detection processing. The CPU 201 then calculates the degree of similarity of the identified face region to each of all feature amount data serving as templates. If the degree of similarity is equal to or higher than a predetermined value, information indicating the selected image as an image expected to include the target person is stored in the primary storage unit 203. After the CPU 201 determines whether the selected image includes the target person for all images stored in the secondary storage unit 202, it displays a list of images expected to include the target person on the display unit 204.

In step S508, the CPU 201 obtains an image including the target person selected by the user from the list of images expected to include the target person displayed on the display unit 204. More specifically, the CPU 201 stands by to receive, from the operation unit 206, a control signal corresponding to an instruction by the user to exclude an image expected to include the target person from the display list as an image which does not include the target person. When the CPU 201 receives a control signal corresponding to an instruction to exclude a given image from the display list, it deletes information indicating the image specified in the instruction from the primary storage unit 203. Also, when the CPU 201 receives, from the operation unit 206, a control signal indicating completion of extraction of images including the target person, it advances the process to step S509.

In step S509, the CPU 201 determines images to be included in the face dictionary of the target person among the extracted images including the target person. More specifically, the CPU 201 determines, as images to be included in the face dictionary, a maximum number of images of pieces of face image information to be included in the face dictionary data in descending order of, for example, degree of similarity calculated in step S507. The CPU 201 stores information indicating the determined images to be included in the face dictionary in the primary storage unit 203, and advances the process to step S510.

In step S510, the CPU 201 performs face detection processing for each of the images to be included in the face dictionary determined in step S509 to extract a face image. The CPU 201 further obtains the feature amount of the face region of each of the extracted face images. The CPU 201 writes face image data and feature amount data of each face image in the face image information of the face dictionary data selected in step S502, or the new face dictionary data generated in step S503.

In step S511, the CPU 201 stores the face dictionary data of the target person in the secondary storage unit 202 as a face dictionary file. At this time, the CPU 201 obtains the current date/time, and writes and stores it in the update date/time 401 of the face dictionary data of the target person.

In this embodiment, by executing camera face dictionary editing processing and PC face dictionary editing processing in this way, the digital camera 100 and PC 200 can newly generate or edit a face dictionary having person's names represented by different character encoding schemes.

<Image Capture Processing>

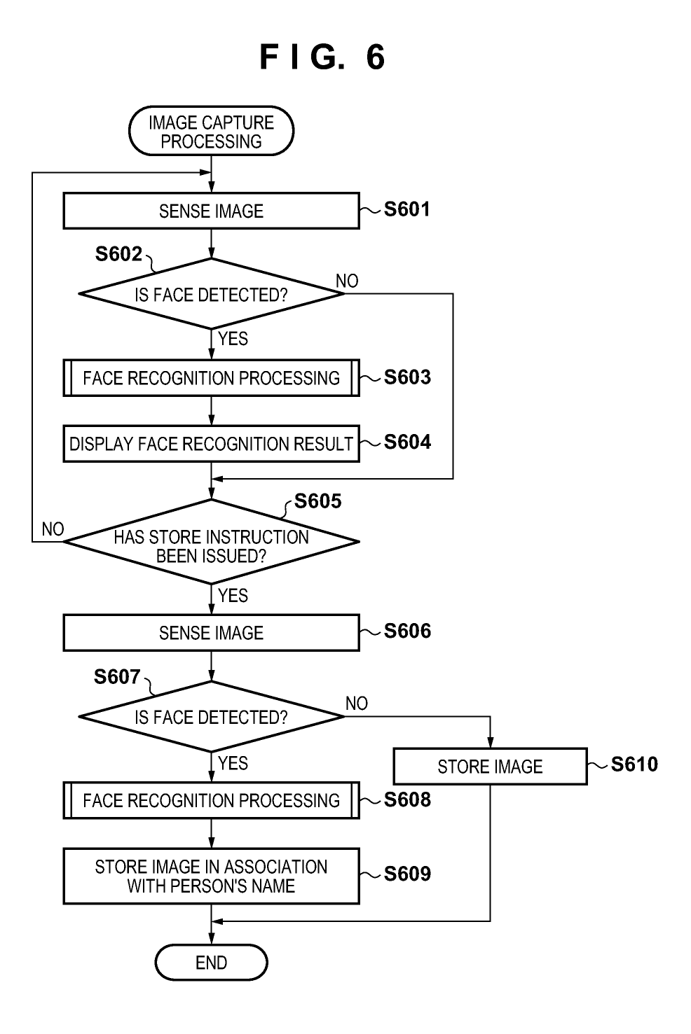

Image capturing processing of storing an image sensed by the digital camera 100 according to this embodiment will be described in detail below with reference to a flowchart shown in FIG. 6. The processing corresponding to this flowchart can be implemented by, for example, making the camera CPU 101 read out a corresponding processing program stored in the camera secondary storage unit 102, expand it into the camera primary storage unit 103, and execute it. Note that the image capture processing starts as, for example, the digital camera 100 is activated in the image capture mode.

In step S601, the camera CPU 101 controls the camera optical system 104 and camera image sensing unit 105 to perform an image sensing operation, thereby obtaining a sensed image. The sensed image obtained at this time is displayed on the camera display unit 107 in step S604 (to be described later), so the photographer presses the shutter button at a preferred timing upon changing the composition and image capture conditions while viewing this image. Processing of displaying an image obtained by the camera image sensing unit 105 as needed in the image capture mode is called “through image display”.

In step S602, the camera CPU 101 determines whether the sensed image includes the face of a person. More specifically, the camera CPU 101 executes face detection processing for the sensed image to determine whether a face region is detected. If the camera CPU 101 determines that the sensed image includes the face of a person, it advances the process to step S603; otherwise, it displays the sensed image on the camera display unit 107, and advances the process to step S605.

In step S603, the camera CPU 101 executes face recognition processing for the faces of all persons included in the sensed image to identify person's names. More specifically, the camera CPU 101 selects the faces of the persons included in the sensed image one by one, and executes face recognition processing for an image of the face region of each person.

(Face Recognition Processing)

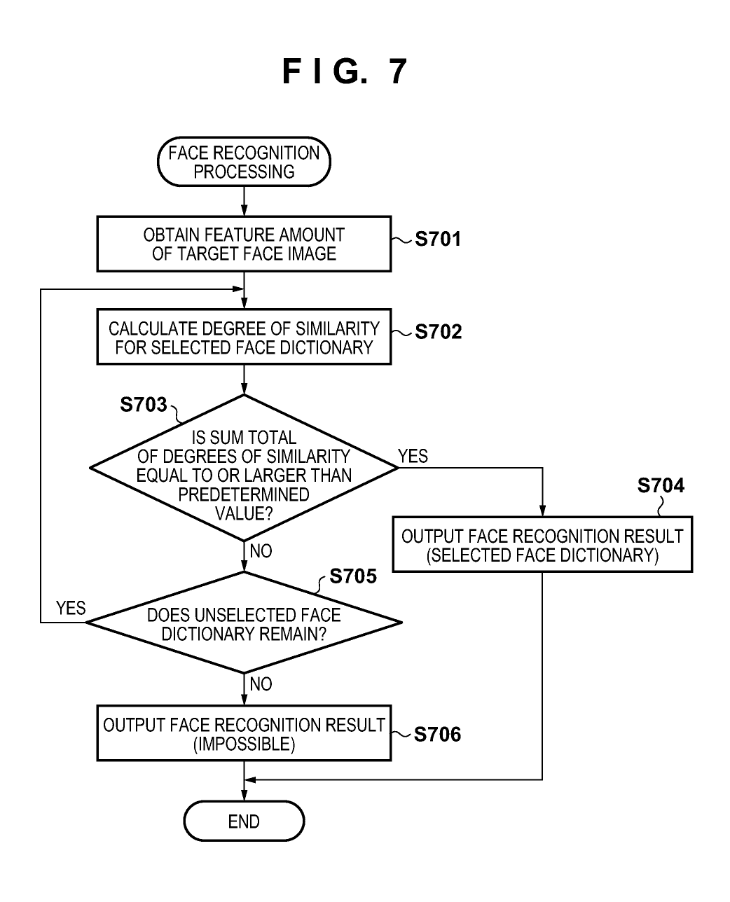

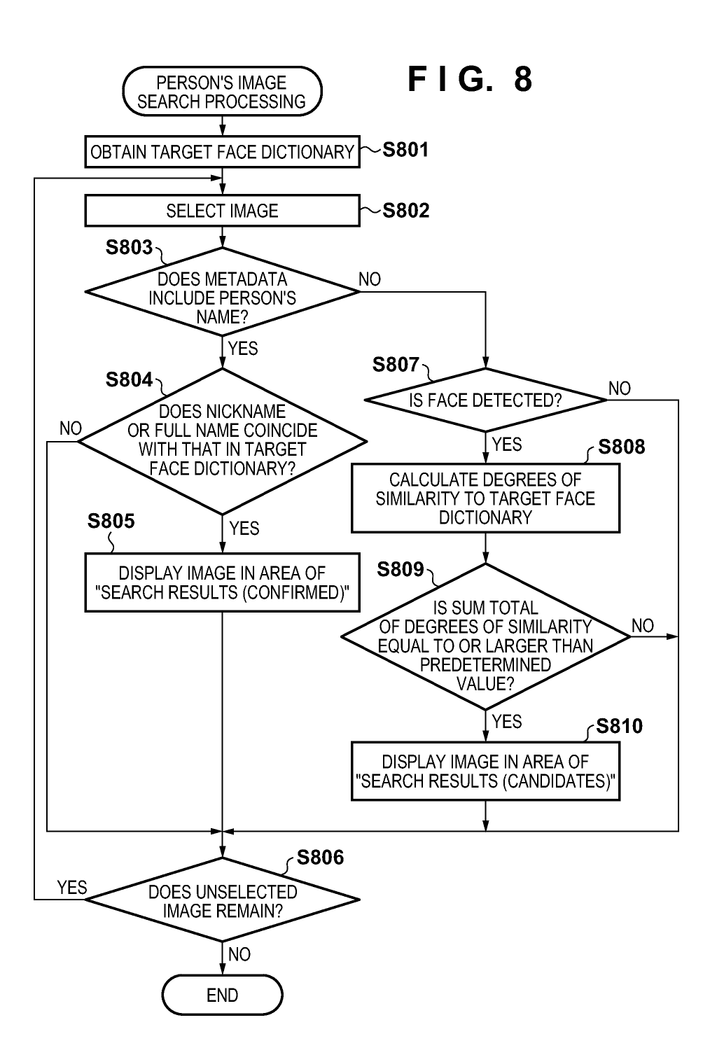

Face recognition processing executed by the digital camera 100 according to this embodiment will be described in detail herein with reference to a flowchart shown in FIG. 7.

In step S701, the camera CPU 101 obtains the feature amount of a face region for one face image (target face image).

In step S702, the camera CPU 101 selects one unselected face dictionary from the face dictionaries stored in the camera storage 106. The camera CPU 101 then calculates the degree of similarity of the feature amount of the target face image obtained in step S701 to that of each face image included in the selected face dictionary.

In step S703, the camera CPU 101 determines whether the sum total of the degrees of similarity calculated in step S702 is equal to or larger than a predetermined value. If the camera CPU 101 determines that the sum total of the degrees of similarity is equal to or larger than the predetermined value, it advances the process to step S704; otherwise, it advances the process to step S705.

In step S704, the camera CPU 101 stores information indicating the currently selected face dictionary in the camera primary storage unit 103 as a face recognition result, and completes the face recognition processing.

On the other hand, if the camera CPU 101 determines in step S703 that the sum total of the degrees of similarity is smaller than the predetermined value, it determines whether an unselected face dictionary remains in the camera storage 106. If the camera CPU 101 determines in step S705 that an unselected face dictionary remains in the camera storage 106, it returns the process to step S702; otherwise, it advances the process to step S706.

In step S706, the camera CPU 101 stores information indicating that face recognition has been impossible in the camera primary storage unit 103 as a face recognition result, and completes the face recognition processing.

After executing face recognition processing in this way, the camera CPU 101 advances the process to step S604.

In step S604, the camera CPU 101 displays the sensed image on the camera display unit 107 serving as a viewfinder as a through image. At this time, the camera CPU 101 looks up the face recognition result stored in the camera primary storage unit 103 to vary the contents displayed on the camera display unit 107, depending on the face recognition result. More specifically, when information indicating a face dictionary is stored in the camera primary storage unit 103 as a face recognition result, the camera CPU 101 displays a frame around the face region of the corresponding person. The camera CPU 101 then displays a character string image of the person's name in the nickname 402 included in the face dictionary on the camera display unit 107 upon superposing it on the through image. However, when information indicating that face recognition has been impossible is stored as a face recognition result, the camera CPU 101 displays the sensed image on the camera display unit 107 without superposition of an image of neither a frame nor a name.

In step S605, the camera CPU 101 determines whether the user has issued a sensed image store instruction. More specifically, the camera CPU 101 determines whether it has received, from the camera operation unit 109, a control signal corresponding to a store instruction. If the camera CPU 101 determines that the user has issued a sensed image store instruction, it advances the process to step S606; otherwise, it returns the process to step S601.

In step S606, as in step S601, the camera CPU 101 obtains a new sensed image, and stores the obtained image in the camera primary storage unit 103 as a storage image.

In step S607, as in step S602, the camera CPU 101 determines whether the storage image includes the face of a person. If the camera CPU 101 determines that the storage image includes the face of a person, it advances the process to step S608; otherwise, it advances the process to step S610.

In step S608, the camera CPU 101 executes face recognition processing for the faces of all persons included in the storage image to identify a person's name corresponding to the face of each person.

In step S609, the camera CPU 101 looks up the face recognition result for each face included in the storage image to include, as metadata, a person's name included in a face dictionary if information indicating the face dictionary is stored, and stores the storage image in the camera storage 106 as an image file.

At this time, the camera CPU 101 determines whether person's names have been input in the fields of the nickname 402 and full name 403 of the face dictionary stored as the face recognition results. If the camera CPU 101 determines that a person's name has been input in each field, it includes the information of this field as metadata, and stores an image file. That is, if the user has issued a sensed image store instruction, the camera CPU 101 stores the pieces of information of all person's names included in the image for the image in the face dictionary corresponding to the face recognition results of persons included in the image.

If the camera CPU 101 determines in step S607 that the storage image includes the face of no person, it stores the storage image as an image file without including any person's name as metadata in step S610.

In this manner, in the digital camera 100 of this embodiment, when a face dictionary for a person identified as a result of face recognition result for a sensed image to be stored includes a second person's name, this image can be stored in association with the second person's name.

<Person's Image Search Processing>

Person's image search processing of searching for an image including a target person by the PC 200 according to this embodiment will be described in detail below with reference to a flowchart shown in FIG. 8. The processing corresponding to this flowchart can be implemented by, for example, making the CPU 201 read out a corresponding processing program stored in the secondary storage unit 202, expand it into the primary storage unit 203, and execute it. Note that the person's image search processing starts as the user performs a human name search of an image on the image browsing application running on the PC 200.

In this embodiment, a method of searching a list of person's names included in all face dictionaries stored in the secondary storage unit 202 for the person's name selected by the user will be explained as a person's name search method on the image browsing application.

In step S801, the CPU 201 obtains the face dictionary corresponding to the person's name selected by the user. More specifically, the CPU 201 looks up the fields of the nickname 402, full name 403, and face detailed information 404 for all face dictionaries stored in the secondary storage unit 202 to obtain a face dictionary (target face dictionary) including the selected person's name.

In step S802, the CPU 201 selects an unselected image (selection image) from the images stored in the secondary storage unit 202.

In step S803, the CPU 201 looks up the metadata of the selection image to determine whether this metadata includes a person's name. If the CPU 201 determines that the metadata of the selection image includes a person's name, it advances the process to step S804; otherwise, it advances the process to step S807.

In step S804, the CPU 201 determines whether the person's name included in the metadata of the selection image coincides with that included in the nickname 402 or full name 403 of the target face dictionary. If the CPU 201 determines that the person's name included in the metadata of the selection image coincides with the nickname or full name included in the target face dictionary, it advances the process to step S805; otherwise, it advances the process to step S806.

In step S805, the CPU 201 adds the selection image to a display list in the area of “search results (confirmed)” on the GUI of the image browsing application as an image including the face of the target person, and displays this image on the camera display unit 107.

In step S806, the CPU 201 determines whether an unselected image remains in the secondary storage unit 202. If the CPU 201 determines that an unselected image remains in the secondary storage unit 202, it returns the process to step S802; otherwise, it completes the person's image search processing.

On the other hand, if the CPU 201 determines in step S803 that the metadata of the selection image includes no person's name, it determines whether the selection image includes the face of a person. More specifically, the CPU 201 executes face detection processing for the selection image to determine whether a face region is detected. If the CPU 201 determines in step S807 that the selection image includes the face of a person, it advances the process to step S808; otherwise, it advances the process to step S806.

In step S808, the CPU 201 calculates the degrees of similarity of the faces of all persons included in the selection image to the face image included in the target face dictionary. More specifically, first, the CPU 201 obtains the feature amount of the face region of the face of each of all persons included in the selection image. The CPU 201 then reads out pieces of face image information included in the target face dictionary one by one, and calculates the degrees of similarity between the feature amounts included in the pieces of face image information, and that of the face region included in the selection image.

In step S809, the CPU 201 determines whether the sum total of the degrees of similarity calculated in step S808 is equal to or larger than a predetermined value. If the CPU 201 determines that the sum total of the degrees of similarity is equal to or larger than the predetermined value, it advances the process to step S810; otherwise, it advances the process to step S806.

In step S810, the CPU 201 adds the selection image to a display list in the area of “search results (candidates)” on the GUI of the image browsing application as an image expected to include the face of the target person, and displays this image on the camera display unit 107.

In this manner, in the image browsing application running on the PC 200 in this embodiment, when an image search is performed using a person's name, an image associated with the person's name, and an image expected to include a person corresponding to the person's name can be classified and displayed.

Note that for an image classified into the area of “search results (candidates)” by the person's image search processing, “correct” and “incorrect” mark buttons, for example, are displayed, together with the image, to allow the user to determine whether the image reliably includes the face of the target person. This implements an operation of, for example, confirming the target person not as a candidate but as an identical person upon selection of the “correct” mark, and confirming him or her as a different person upon selection of the “incorrect” mark. When an operation of reliably confirming the target person as an identical person is accepted, it is desired to store the person's name of the target person in the metadata of the image. Also, after the user deletes images which do not include the face of the target person among images included in the display list of search results (candidates), the CPU 201 may include, in the metadata, all person's names included in the target face dictionary for the remaining images.

After a personal name included in the face dictionary is stored in the metadata of each image, a corresponding image is displayed in the area of “search results (confirmed)” when a search is performed using the person's name of an identical person thereafter.

<Connection Time Processing>

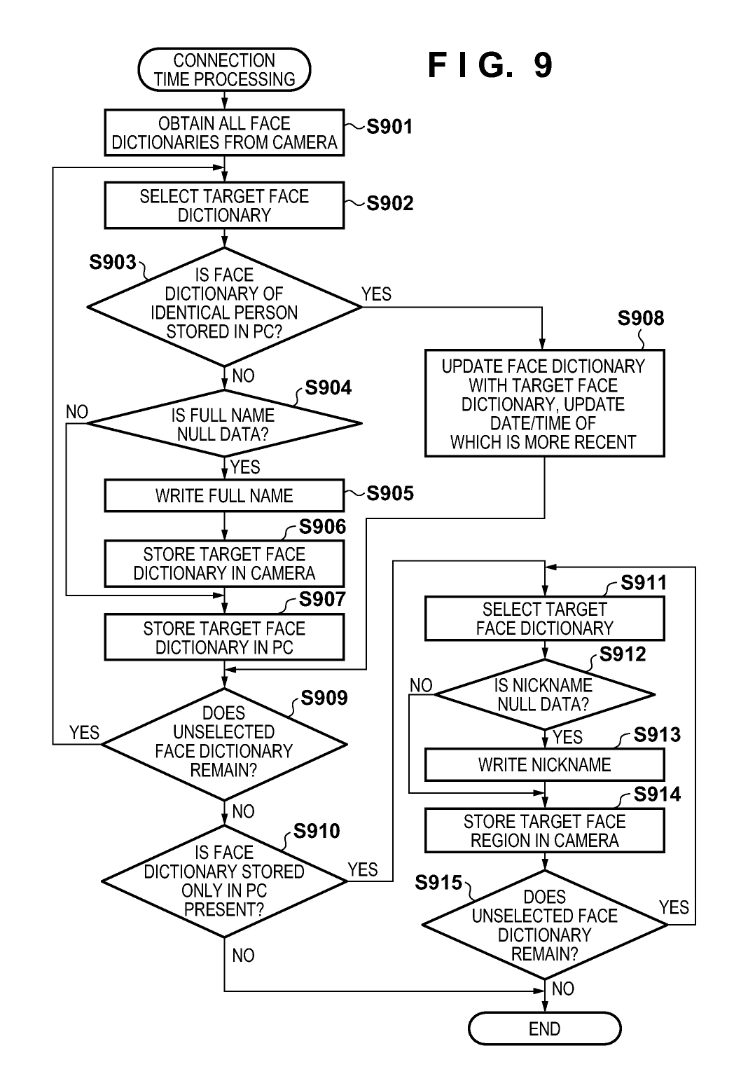

Connection time processing of sharing a face dictionary between the digital camera 100 and the PC 200 by the PC 200 according to this embodiment will be described in detail below with reference to a flowchart shown in FIG. 9. The processing corresponding to this flowchart can be implemented by, for example, making the CPU 201 read out a corresponding processing program stored in the secondary storage unit 202, expand it into the primary storage unit 203, and execute it. Note that the connection time processing starts as, for example, the digital camera 100 and the PC 200 are connected to each other while the image browsing application runs on the PC 200.

In step S901, the CPU 201 obtains all face dictionaries stored in the camera storage 106 of the digital camera 100 via the communication unit 205, and stores them in the primary storage unit 203.

In step S902, the CPU 201 selects an unselected face dictionary (target face dictionary) from the face dictionaries stored in the primary storage unit 203 in step S901.

In step S903, the CPU 201 determines whether a face dictionary for the person specified in the target face dictionary is stored in the secondary storage unit 202.

(Identical Face Dictionary Determination Processing)

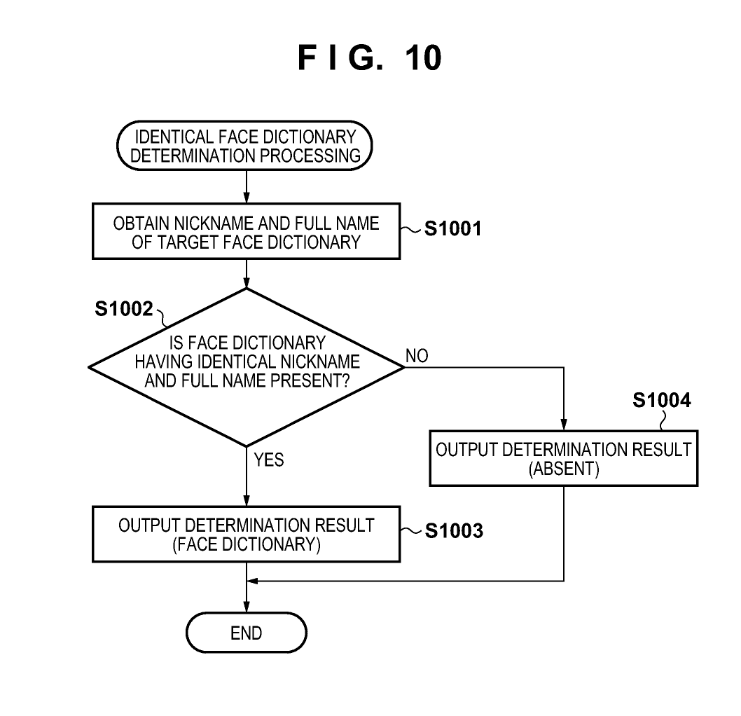

Identical face dictionary determination processing of determining whether a face dictionary for the person specified in the target face dictionary is stored in the secondary storage unit 202 according to this embodiment will be described in detail herein with reference to a flowchart shown in FIG. 10.

In step S1001, the CPU 201 obtains the information of the fields of the nickname 402 and full name 403 of the target face dictionary.

In step S1002, the CPU 201 determines whether a face dictionary having a nickname 402 and full name 403 identical to those of the target face dictionary is stored in the secondary storage unit 202. If the CPU 201 determines that a face dictionary having a nickname 402 and full name 403 identical to those of the target face dictionary is stored in the secondary storage unit 202, it advances the process to step S1003; otherwise, it advances the process to step S1004.

In step S1003, the CPU 201 stores, in the primary storage unit 203 as a determination result, information indicating the face dictionary having the nickname 402 and full name 403 identical to those of the target face dictionary, and completes the identical face dictionary determination processing.

In step S1004, the CPU 201 stores, in the primary storage unit 203 as a determination result, information indicating that no face dictionary for the person specified in the target face dictionary is stored in the secondary storage unit 202, and completes the identical face dictionary determination processing.

If the CPU 201 looks up a determination result obtained by executing identical face dictionary determination processing, and confirms that the determination result is information indicating that no face dictionary for the person specified in the target face dictionary is stored in the secondary storage unit 202, it advances the process to step S904. This means that the target face dictionary is either a face dictionary which has not yet been transferred to the PC 200 after being generated by the digital camera 100, or a face dictionary deleted from the secondary storage unit 202 of the PC 200.

However, if the CPU 201 confirms that the determination result is information indicating a specific face dictionary, it determines that a face dictionary for the person specified in the target dictionary is stored in the secondary storage unit 202, and advances the process to step S908.

In step S904, the CPU 201 determines that the full name 403 of the target dictionary is null data (initial data). If the CPU 201 determines that the full name 403 of the target face dictionary is null data, it advances the process to step S905; otherwise, it advances the process to step S907.

In step S905, the CPU 201 accepts input of a full name for the target face dictionary. More specifically, the CPU 201 displays, on the display unit 204, a screen generated using GUI data for accepting input of a full name. The CPU 201 then stands by to receive, from the operation unit 206, a control signal indicating completion of input of a full name by the user. When the CPU 201 receives, from the operation unit 206, a control signal indicating completion of input of a full name, it obtains the input full name and writes it in the field of the full name 403 of the target face dictionary. At this time, the CPU 201 also obtains the current date/time and writes it in the field of the update date/time 401 of the target face dictionary.

In step S906, the CPU 201 stores the target face dictionary written with the full name in the camera storage 106 via the communication unit 205. At this time, the CPU 201 updates or deletes the target face dictionary that has no full name and is stored in the camera storage 106, and stores a new target face dictionary. That is, in step S906, the full name set by the user is added to the face dictionary generated by the digital camera 100. Hence, not only a nickname but also a full name can be associated with a sensed image, which includes the face of the person specified in the target face dictionary, among sensed images stored by the digital camera 100 thereafter.

In step S907, the CPU 201 moves the target face dictionary from the primary storage unit 203 to the secondary storage unit 202, and stores it in the secondary storage unit 202. This means that in step S907, the face dictionary generated by the digital camera 100 is written with a full name, and stored in the secondary storage unit 202 as a face dictionary managed by the image browsing application.

On the other hand, if the CPU 201 determines in step S903 that a face dictionary for the person specified in the target face dictionary is stored in the secondary storage unit 202, in step S908 it compares the update date/time 401 of the corresponding face dictionary identified by the identical face dictionary determination processing with that of the target face dictionary. At this time, if the update date/time of the target face dictionary is more recent, the CPU 201 updates the corresponding face dictionary, stored in the secondary storage unit 202, using the target face dictionary. However, if the update date/time of the corresponding face dictionary is more recent, the CPU 201 transfers this face dictionary to the camera storage 106 via the communication unit 205, and updates the target face dictionary stored in the camera storage 106.

In step S909, the CPU 201 determines whether a face dictionary that has not yet been selected as a target face dictionary remains in the primary storage unit 203. If the CPU 201 determines that an unselected face dictionary remains in the primary storage unit 203, it returns the process to step S902; otherwise, it advances the process to step S910.

In step S910, the CPU 201 determines the presence/absence of a face dictionary which is not stored in the camera storage 106 of the digital camera 100 and is stored only in the secondary storage unit 202 of the PC 200. More specifically, the CPU 201 determines the presence/absence of a face dictionary which has not been selected as a corresponding face dictionary as a result of executing identical face dictionary determination processing for all face dictionaries obtained from the camera storage 106 of the digital camera 100 in step S901. If the CPU 201 determines that a face dictionary stored only in the secondary storage unit 202 of the PC 200 is present, it advances the process to step S911; otherwise, it completes the connection time processing.

In step S911, the CPU 201 selects, as a target face dictionary, an unselected face dictionary among face dictionaries stored only in the secondary storage unit 202.

In step S912, the CPU 201 determines whether the nickname 402 of the target face dictionary is null data. If the CPU 201 determines that the nickname 402 of the target face dictionary is null data, it advances the process to step S913; otherwise, it advances the process to step S914.

In step S913, the CPU 201 accepts input of a nickname for the target face dictionary. More specifically, the CPU 201 displays, on the display unit 204, a screen generated using GUI data for accepting input of a nickname. The CPU 201 then stands by to receive, from the operation unit 206, a control signal indicating completion of input of a nickname by the user. When the CPU 201 receives, from the operation unit 206, a control signal indicating completion of input of a full name, it obtains the input nickname and writes it in the field of the nickname 402 of the target face dictionary. At this time, the CPU 201 also obtains the current date/time and writes it in the field of the update date/time 401 of the target face dictionary.

In step S914, the CPU 201 transfers the target face dictionary via the communication unit 205, and stores it in the camera storage 106 of the digital camera 100. This means that in step S914, the face dictionary generated by the PC 200 is stored in the camera storage 106 of the digital camera 100 as a face dictionary to be used in face recognition processing.

In step S915, the CPU 201 determines the presence/absence of a face dictionary which has not yet been selected as a target face dictionary and is stored only in the secondary storage unit 202. If the CPU 201 determines that a face dictionary which has not yet been selected as a target face dictionary and is stored only in the secondary storage unit 202 is present, it returns the process to step S911; otherwise, it completes the connection time processing.

This makes it possible to share face dictionaries stored only in individual devices, and update the face dictionaries to the latest states with each other, when the digital camera 100 and the PC 200 are connected to each other.

As described above, the image sensing apparatus in this embodiment can achieve at least one of the display of a face recognition result while ensuring a given user visibility, and the storage of an image compatible with a flexible person's name search. More specifically, the image sensing apparatus performs face recognition processing using face recognition data for each registered person, who has a first person's name corresponding to a first character code capable of being input and displayed in the image sensing apparatus, and a second person's name corresponding to a second character code different from the first character code. When the image sensing apparatus obtains a face image to be included in face recognition data to be generated, it accepts input of the first person's name corresponding to the obtained face image, and generates and stores face recognition data in association with the face image, or the feature amount of the face image and the first person's name. Also, the image sensing apparatus performs face recognition processing for a sensed image using the stored face recognition data, and stores the first person's name corresponding to the identified person included in the sensed image in association with the sensed image. At this time, the image sensing apparatus stores the sensed image with a second person's name when the second person's name is associated with the face recognition data corresponding to the identified person.

### First Modification

In the above-mentioned embodiment, in identical face dictionary determination processing, it is determined whether both nicknames and full names in different face dictionaries coincide with each other, based on whether a face dictionary for the person specified in the target face dictionary is stored in the secondary storage unit 202. However, in this method, if different persons with the same nickname and full name, that is, the same family and personal name are present, different face dictionaries may be erroneously recognized to indicate the same person, or the face dictionary of one person may be updated using the face dictionary of another person. Identical face dictionary determination processing that can cope with even the situation in which different persons with the same nickname and full name, that is, the same family and personal name are present will be described in this modification.

<Identical Face Dictionary Determination Processing>

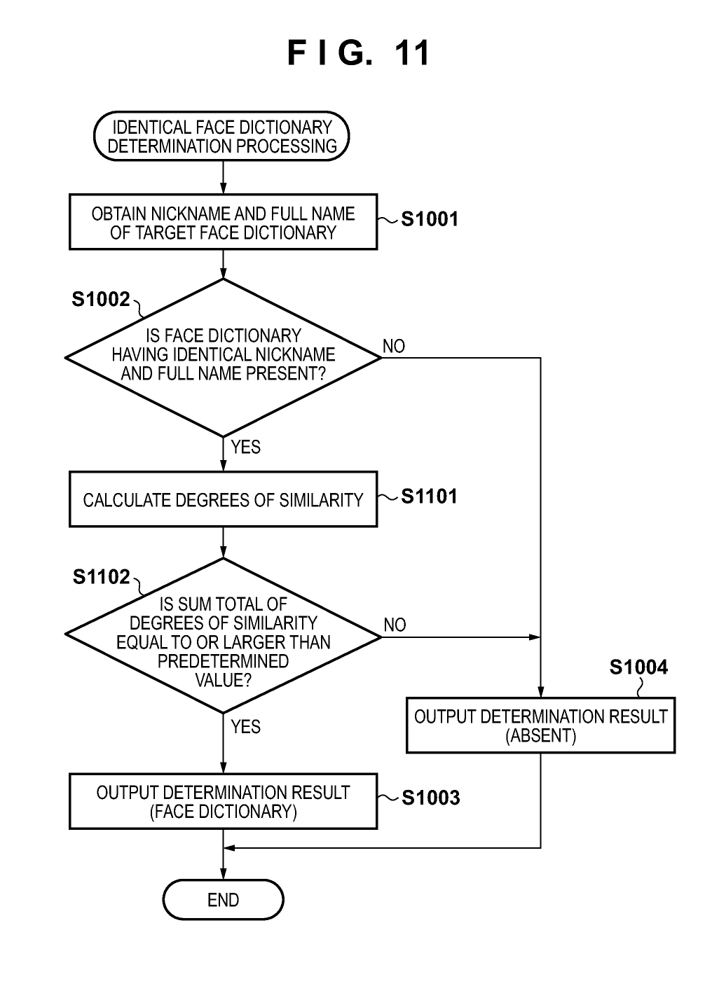

Identical face dictionary determination processing according to this modification will be described below with reference to a flowchart shown in FIG. 11. Note that in the identical face dictionary determination processing of this modification, the same reference numerals as in the above-mentioned embodiment denote steps in which the same processes are performed, and a description thereof will not be given, so only steps in which characteristic processes unique to this modification will be described.

If the CPU 201 determines in step S1002 that a face dictionary having a nickname 402 and full name 403 identical to those of the target face dictionary is stored in the secondary storage unit 202, it advances the process to step S1101.

In step S1101, the CPU 201 calculates the degrees of similarity between the feature amounts of all face images included in the target face dictionary, and those of all face images included in the face dictionary having the nickname 402 and full name 403 identical to those of the target face dictionary.

In step S1102, the CPU 201 determines whether the sum total of the degrees of similarity calculated in step S1101 is equal to or larger than a predetermined value. If the CPU 201 determines that the sum total of the degrees of similarity is equal to or larger than the predetermined value, it advances the process to step S1003; otherwise, it advances the process to step S1004.

Upon this operation, even if face dictionaries for different persons with the same family and personal name are present, the face dictionaries can be managed without loss upon update.

### Second Modification

In either of the above-mentioned embodiment and first modification, the face dictionary includes only one type of nickname serving as a first person's name, and only one type of full name serving as a second person's name. However, to attain an image search using person's names at a high level of freedom, a plurality of second person's names may be used. In this case, when the face dictionary for the same person stored in the digital camera 100 and PC 200 in the connection time processing is updated using either face dictionary in accordance with the update date/time, the second person's name may be lost.

The case wherein, for example, the face dictionary for the same person is shared between the digital camera 100 and the PC 200, a second person's name is added to the PC face dictionary in the PC 200, and a new face image is added to the camera face dictionary in the digital camera 100 will be considered. In this case, since the update date/time of the camera face dictionary is more recent, the CPU 201 updates the PC face dictionary using the camera face dictionary when the digital camera 100 and the PC 200 are connected to each other. At this time, the second person's name added to the PC face dictionary is lost upon update.

Person's name merge processing in the connection time processing when a plurality of full names are included in the face dictionary will be described in this modification.

<Person's Name Merge Processing>

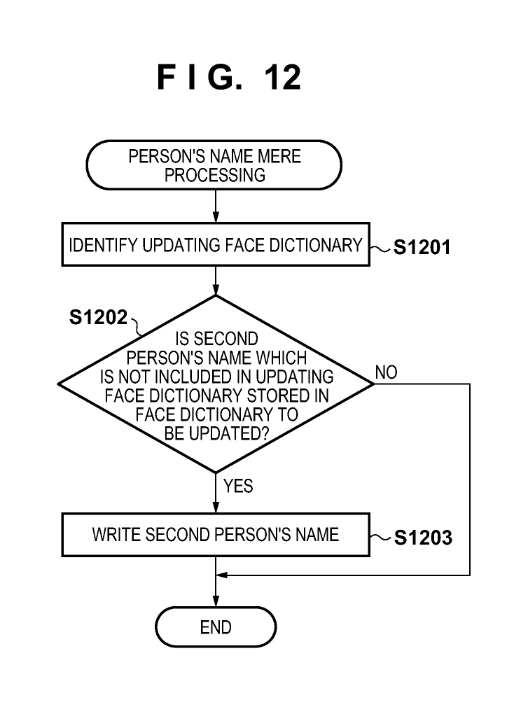

Person's name merge processing according to this modification will be described below with reference to a flowchart shown in FIG. 12. Note that the person's name merge processing is executed at the time of, for example, a comparison in update date/time before the face dictionary is updated in step S908 of the connection time processing.

In step S1201, the CPU 201 compares the update date/time 401 of the corresponding face dictionary identified by the identical face dictionary determination processing with that of the target face dictionary to identify a face dictionary (updating face dictionary), the update date/time is more recent than the other.

In step S1202, the CPU 201 determines the presence/absence of a second person's name which is included in the face dictionary (face dictionary to be updated), the update date/time of which is older, and is not included in the updating face dictionary. More specifically, the CPU 201 compares the full name 403 of the updating face dictionary with the full name 403 of the face dictionary to be updated to determine whether a second person's name which is not included in the updating face dictionary is present. If the CPU 201 determines that the face dictionary to be updated includes a second person's name which is not included in the updating face dictionary, it advances the process to step S1203; otherwise, it completes the person's name merge processing.

In step S1203, the CPU 201 obtains a second person's name which is included in the face dictionary to be updated and is not included in the updating face dictionary, and writes it in the field of the full name 403 of the updating face dictionary. At this time, the CPU 201 also obtains the current date/time and writes it in the field of the update date/time 401 of the updating face dictionary.

Upon this operation, the face dictionary can be updated without loss of a second person's name even when a plurality of second person's names are included in the face dictionary.

Although the face dictionary to be updated includes a second person's name which is not included in the updating face dictionary in this modification, the same applies to the first person's name. In this case, in identical face dictionary determination processing, it is determined whether the face dictionary of the same person is stored in both the digital camera 100 and PC 200, based on whether at least one of the same first person's name and the same second person's name is stored in this face dictionary.

### Third Modification

In the above-mentioned connection time processing, the CPU 201 transfers, to an image sensing apparatus connected to the PC 200, a face dictionary which is not stored in the image sensing apparatus. However, when, for example, an image sensing apparatus of another person is connected to the PC 200, it is often undesirable for the user to transfer a face dictionary and a face image included in it to the image sensing apparatus of this person.

Hence, the CPU 201 may inquire of the user whether he or she permits the transfer operation of a face dictionary to an image sensing apparatus other than an image sensing apparatus which has generated the face dictionary, before the face dictionary is stored in the PC 200. Information indicating whether the user permits this transfer operation need only be associated with the face dictionary stored in, for example, the secondary storage unit 202. In this case, as the information of an image sensing apparatus which has generated a face dictionary, both the USB IDs (vendor ID and product ID) of the image sensing apparatus need only be associated with the face dictionary.

### Fourth Modification

The display of a face recognition result while ensuring a given user visibility, and the storage of an image compatible with a flexible person's name search can also be achieved using a technique other than those in the above-mentioned embodiment and modifications. This can be done by, for example, limiting the maximum data length (first maximum data length) of a first person's name to be registered for use in simple display of a face recognition result, and setting a second maximum data length other than the first maximum data length for a second person's name intended for a search using a person's name at a high level of freedom.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-280245, filed Dec. 21, 2011, which is hereby incorporated by reference herein in its entirety.

What is claimed is:

1. An image sensing apparatus comprising:
a management unit configured to manage face recognition data, which is to be used in recognizing a person corresponding to a face image, and in which a feature amount of the face image, a first person's name, and a second person's name different from the first person's name are managed in association with each other for each registered person;
a face recognition unit configured to identify a person, corresponding to a face image included in a captured image, using the feature amount managed in the face recognition data;
a storage unit configured to store the second person's name for the person, identified by said face recognition unit, in a storage in association with the captured image; and
a display control unit configured to read out the image stored in the storage, and display the readout image on a display unit together with the first person's name managed in the face recognition data in association with the second person's name associated with the readout image.

2. An image sensing apparatus comprising:
a management unit configured to manage face recognition data, which is to be used in recognizing a person corresponding to a face image, and in which a feature amount of the face image, a first person's name, and a second person's name different from the first person's name are managed for each registered person;
a face recognition unit configured to identify a person, corresponding to a face image included in a through image output from an image sensing unit, using the feature amount managed in the face recognition data;
a display control unit configured to display, on the display unit together with the through image, the first person's name for the person identified by said face recognition unit; and
a storage unit configured to store, in a storage, a sensed image output from the image sensing unit when an image capture instruction is issued, and the second person's name for the person identified by said face recognition unit for the sensed image, upon associating the sensed image with the second person's name.

3. The apparatus according to claim 1, wherein the first person's name includes a nickname, and the second person's name includes a full name.

4. The apparatus according to claim 1, wherein the first person's name and the second person's name have maximum data lengths determined in advance, and the maximum data length of the second person's name is larger than the maximum data length of the first person's name.

5. The apparatus according to claim 1, wherein a character encoding scheme of the first person's name is different from a character encoding scheme of the second person's name.

6. The apparatus according to claim 1, wherein the first person's name is stored upon one-byte character encoding, and the second person's name is stored upon two-byte character encoding.

7. The apparatus according to claim 1, wherein a character encoding scheme of the second person's name uses a character code capable of being input and displayed in an external apparatus.

8. An information processing apparatus that manages face recognition data which is stored in an image sensing apparatus, which is to be used in recognizing a person corresponding to a face image, and in which a feature amount of the face image and a first person's name are associated with each other for each registered person, the information processing apparatus comprising:
an obtaining unit configured to obtain the face recognition data from the image sensing apparatus;
an input unit configured to associate the person registered in the face recognition data obtained by said obtaining unit with a second person's name different from the first person's name; and
a transmission unit configured to transmit the face recognition data associated with the second person's name by said input unit to the image sensing apparatus.

9. A control method for an image sensing apparatus, the method comprising:
a management step of managing face recognition data which is to be used in recognizing a person corresponding to a face image, and in which a feature amount of the face image, a first person's name, and a second person's name different from the first person's name are managed in association with each other for each registered person;
a face recognition step of identifying a person, corresponding to a face image included in a captured image, using the feature amount managed in the face recognition data;
a storage step of storing the second person's name for the person, identified in the face recognition step, in a storage in association with the captured image; and
a display control step of reading out the image stored in the storage, and displaying the readout image on a display unit together with the first person's name managed in the face recognition data in association with the second person's name associated with the readout image.

10. A control method for an image sensing apparatus, the method comprising:
a management step of managing face recognition data, which is to be used in recognizing a person corresponding to a face image, and in which a feature amount of the face image, a first person's name, and a second person's name different from the first person's name are managed for each registered person;
a face recognition step of identifying a person, corresponding to a face image included in a through image output from an image sensing unit, using the feature amount managed in the face recognition data;
a display control step of displaying, on the display unit together with the through image, the first person's name for the person identified in the face recognition step; and
a storage step of storing, in a storage, a sensed image output from the image sensing unit when an image capture instruction is issued, and the second person's name for the person identified in the face recognition step for the sensed image, upon associating the sensed image with the second person's name.

11. A control method for an information processing apparatus that manages face recognition data which is stored in an image sensing apparatus, which is to be used in recognizing a person corresponding to a face image, and in which a feature amount of the face image and a first person's name are associated with each other for each registered person, comprising the steps of:
an obtaining step of obtaining the face recognition data from the image sensing apparatus;
an input step of associating the person registered in the face recognition data obtained in the obtaining step with a second person's name different from the first person's name; and
a transmission step of transmitting the face recognition data associated with the second person's name in the input step to the image sensing apparatus.

12. A computer readable storage medium storing a program for causing a computer to execute each step in a control method for an image sensing apparatus, defined in claim 9.

13. A computer readable storage medium storing a program for causing a computer to execute each step in a control method for an image sensing apparatus, defined in claim 10.

14. A computer readable storage medium storing a program for causing a computer to execute each step in a control method for an information processing apparatus, defined in claim 11.
